(19) United States
(12) Patent Application Publication
(10) Pub. No.: US 2008/0026271 A1
(43) Pub. Date: Jan. 31, 2008

(54) Fuel Cell Power Generation System

(76) Inventors: Tetsuya Ueda, Aichi (JP); Shinji Miyauchi, Nara (JP); Yoshikazu Tanaka, Kyoto (JP)

Correspondence Address: MCDERMOTT WILL & EMERY LLP, 600 13TH STREET, NW, WASHINGTON, DC, 20005-3096, US

(21) Appl. No.: 11/632,283

(22) PCT Filed: Jul. 14, 2005
(86) PCT No.: PCT/JP05/13054

§ 371 Date: Jan. 12, 2007

(30) Foreign Application Priority Data
Jul. 14, 2004 (JP) 2004-206748

(51) Int. Cl. H01M 8/04

(52) U.S. Cl. 429/23; 429/24; 429/25

(57) ABSTRACT

A fuel cell power generation system includes: a sensor unit (1) capable of sensing an abnormality in operation states; a protection controller device (2) configured to output a predetermined protective operation command signal based on at least an output signal from the sensor unit; a protective operation unit (4) configured to perform a predetermined protective operation based on the protective operation command signal that is output from the protection controller device; and a simulation signal generator (5) configured to output a simulation signal for causing the protection controller device to output the protective operation command signal; the fuel cell power generation system having an abnormality self-diagnostic function to check the protective operation of the protective operation unit by inputting the simulation signal into the protection controller device by the simulation signal generator and thereby causing the protection controller device to output the protective operation command signal; and the protection controller device including a failure determination unit (3) configured to determine a failure in the sensor unit; and the fuel cell power generation system having a failure self-diagnostic function to check the protective operation of the protective operation unit by outputting the protective operation command signal from the protection controller device if the failure determination unit determines a failure in the sensor unit, and to check the protective operation even if the failure determination unit determines no failure in the sensor unit.

### TECHNICAL FIELD

The present invention relates to fuel cell power generation systems for generating electric power by causing a reaction between hydrogen and oxygen.

### BACKGROUND ART

Fuel cell power generation systems, which are capable of highly efficient small-scale electric power generation, have conventionally been used suitably as distributed power generation systems because they enable easy construction of a system for utilizing the thermal energy generated during electric power generation as well as high efficiency in energy utilization.

A fuel cell power generation system has a fuel cell as the main component of its power generation unit. A solid polymer electrolyte fuel cell, a phosphoric acid fuel cell, and the like are commonly used as this fuel cell. These types of fuel cells use hydrogen as a fuel for generating electric power. However, a means to supply hydrogen has currently not yet been provided as an infrastructure. For this reason, the fuel cell power generation system is usually provided with a reformer to generate the hydrogen necessary for generating electric power. The reformer uses a hydrocarbon-based raw fuel such as methane to generate a hydrogen-rich gas (hereinafter referred to as a “reformed gas”), which contains hydrogen abundantly. The fuel cell performs electric power generation using the air and the reformed gas supplied from the reformer.

The fuel cell power generation system is equipped with various diagnostic mechanisms for ensuring safety. For example, the fuel cell power generation system may have a failure diagnostic mechanism associated with the reformed gas supplying mechanism, for diagnosing whether or not the reformed gas is properly supplied from the reformer to the fuel cell. If the failure diagnostic mechanism detects a failure in the reformed gas supplying mechanism, the fuel cell power generation system performs a protective operation, such as stopping the power generation operation. Thus, the fuel cell power generation system ensures safety of the power generation operation by means of various diagnostic mechanisms.

Here, as an example of the diagnostic mechanism for ensuring a safe power generation operation of the fuel cell power generation system, the above-mentioned failure diagnostic mechanism associated with the reformed gas supplying mechanism will be outlined.

FIG. 7 is a block diagram schematically illustrating the configuration of the failure diagnostic mechanism for the reformed gas supplying mechanism in a conventional fuel cell power generation system. It should be noted that FIG. 7 shows the reformed gas supplying mechanism and the failure diagnostic mechanism therefor only in part of the fuel cell power generation system.

As illustrated in FIG. 7, a failure diagnostic mechanism 101 in the conventional fuel cell power generation system comprises: a fuel cell 51 for generating and outputting electric power using a reformed gas and air; a reformed gas supplying pipe 54 for introducing to the fuel cell 51 a reformed gas generated by a reformer, which is not shown in FIG. 7; a first open/close valve 52 and a second open/close valve 53 for permitting/stopping the supply of the reformed gas from the reformer to the fuel cell 51 through the reformed gas supplying pipe 54; actuators 52a and 53a for respectively controlling open/close operations of the first open/close valve 52 and the second open/close valve 53; a pressure sensor 55 (sensor component) for detecting the pressure of the reformed gas in the reformed gas supplying pipe 54; a failure diagnosis unit 56 for controlling the operations of the actuators 52a and 53a and diagnosing abnormalities or failures of the first open/close valve 52 and the second open/close valve 53 according to an output signal from the pressure sensor 55.

Also as illustrated in FIG. 7, the fuel cell 51 is connected to the reformer, not shown in the figure, by the reformed gas supplying pipe 54. The first open/close valve 52 and the second open/close valve 53 are disposed at predetermined locations of the reformed gas supplying pipe 54. The first open/close valve 52 and the second open/close valve 53 are provided with the actuators 52a and 53a, respectively. The pressure sensor 55 is disposed on the reformed gas supplying pipe 54 between the first open/close valve 52 and the second open/close valve 53. The failure diagnosis unit 56 is interconnected to the actuators 52a and 53a, and to the pressure sensor 55 by wires indicated by dashed lines in FIG. 5.

In the failure diagnostic mechanism 101 configured in this way if the pressure sensor 55 detects a pressure value greater than a predetermined pressure value when, for example, both the first open/close valve 52 and the second open/close valve 53 are closed by the failure diagnosis unit 56, the failure diagnosis unit 56 identifies leakage of the first open/close valve 52 and determines that a failure of the first open/close valve 52 has occurred.

On the other hand, if the pressure sensor 55 detects a pressure value greater than a predetermined pressure value when the first open/close valve 52 is opened while the second open/close valve 53 is closed, the failure diagnosis unit 56 identifies leakage of the second open/close valve 53 and determines that a failure of the second open/close valve 53 has occurred.

When the failure diagnosis unit 56 determines that at least one of the first open/close valve 52 or the second open/close valve 53 has failed, a predetermined protective operation, such as stopping the power generation operation, is executed in the fuel cell power generation system (see, for example, Patent Reference 1).

[Patent Reference 1] Japanese Unexamined Patent Publication No. 9-22711

### DISCLOSURE OF THE INVENTION

### Problems the Invention is to Solve

In the above-described conventional configuration, however, there is a risk that an abnormality or failure of the open/close valves may become undetectable due to deterioration over time of the pressure sensing performance of the pressure sensor. In this case, because the abnormality etc. of the open/close valves may become undetectable, a risk arises in the fuel cell power generation system that the protective operation such as stopping of its power generation operation may not be executed properly. For this reason, in order to ensure safety, the above-described conventional configuration has necessitated periodic inspections by human operators to further check whether or not there is an abnormality or failure in the open/close valves.

For example, the first open/close valve 52 and the second open/close valve 53 shown in FIG. 7 are manually operated as appropriate and thereafter the pressure inside the fuel gas supply pipe 54 is measured in the way described above using a calibrated pressure sensor other than the pressure sensor 55, to check whether or not there is an abnormality etc. in the first open/close valve 52 and the second open/close valve 53. In some cases, the open/close valves are taken out of the fuel cell power generation system and the removed open/close valves are inspected one by one, to check whether or not there is an abnormality etc. in the open/close valves. Consequently, a problem has been that the periodic inspections by human operators necessitate extra costs such as personnel costs, raising the maintenance costs of the fuel cell power generation system.

The present invention has been accomplished in order to resolve the foregoing problems, and it is an object of the invention to provide a fuel cell power generation system that is economical in maintenance costs, by periodically checking the protective operation through an abnormality detection or a failure detection even with deterioration over time of a sensor component and also performing self-diagnosis, thereby eliminating the need for periodic inspections.

### Means to Solve the Problems

In order to resolve the foregoing problems, the present invention provides a fuel cell power generation system comprising: a sensor unit capable of sensing an abnormality in operation states; a protection controller device configured to output a predetermined protective operation command signal based on at least an output signal from the sensor unit; a protective operation unit configured to perform a predetermined protective operation based on the protective operation command signal that is output from the protection controller device; and a simulation signal generator configured to output a simulation signal for causing the protection controller device to output the protective operation command signal; the fuel cell power generation system having an abnormality self-diagnostic function to check the protective operation of the protective operation unit by inputting the simulation signal into the protection controller device by the simulation signal generator and thereby causing the protection controller device to output the protective operation command signal; and the protection controller device including a failure determination unit configured to determine a failure in the sensor unit; and the fuel cell power generation system having a failure self-diagnostic function to check the protective operation of the protective operation unit by outputting the protective operation command signal from the protection controller device if the failure determination unit determines a failure in the sensor unit, and by inputting the simulation signal into the protection controller device by the simulation signal generator to cause the protection controller device to output the protective operation command signal even if the failure determination unit determines no failure in the sensor unit.

With this configuration, the abnormality self-diagnostic function periodically checks the protective operation, thus eliminating the need for periodic inspections by human operators and ensuring a safe power generation operation of the fuel cell power generation system. Moreover, it becomes possible to provide a fuel cell power generation system with low maintenance cost. Furthermore, the failure self-diagnostic function periodically checks the protective operation, eliminating the need for the periodic inspections by human operators and ensuring a safe power generation operation of the fuel cell power generation system. Moreover, it becomes possible to provide a fuel cell power generation system with low maintenance cost.

In the foregoing case, the checking of the protective operation may be performed with at least one of the abnormality self-diagnostic function and the failure self-diagnostic function periodically.

By employing the above-described configuration, a safe power generation operation is ensured further since the protective operation is checked with at least one of the abnormality self-diagnostic function and the failure self-diagnostic function periodically.

The fuel cell power generation system may further comprise a raw fuel shutoff unit configured to shut off supply of a raw fuel necessary to generate electric power, and an electric output shutoff unit configured to shut off electric power output from electric power generation, and the protective operation unit may comprise at least one of the raw fuel shutoff unit or the electric output shutoff unit.

With such a configuration, the raw fuel supplied to the fuel cell power generation system is shut off by the raw fuel shutoff unit, or the electric power that is output by the power generation of the fuel cell is shut off by the electric output shutoff unit. This makes it possible to ensure safety of the fuel cell power generation system reliably.

In this case, the sensor unit may comprise at least one of a temperature sensor, a pressure sensor, a voltage sensor, a current sensor, a revolution sensor, and a combustible gas sensor.

Such a configuration makes it possible to detect the operation states of the fuel cell power generation system during its power generation operation, such as temperature, pressure, voltage, current, number of revolutions, and leakage of combustible gas. This ensures safety of the fuel cell power generation system reliably.

In this case, the fuel cell power generation system may further comprise a start/stop command device configured to control start-up or stop of power generation operation; and the protective operation may be checked with at least one of the abnormality self-diagnostic function and the failure self-diagnostic function when a command signal associated with normal stop of the power generation operation that is output from the start/stop command device is input into the protection controller device.

With such a configuration, the checking of the protective operation is performed with at least one of the abnormality self-diagnostic function and the failure self-diagnostic function suitably.

In this case, the sensor unit may comprises a plurality of sensors having different sensing functions from one another, and the checking of the protective operation may be performed with at least one of the abnormality self-diagnostic function and the failure self-diagnostic function for the plurality of sensors in a predetermined sequence.

With such a configuration, the checking of the protective operation is performed with at least the abnormality self-diagnostic function and the failure self-diagnostic function for all the sensors provided at a frequency that is necessary and sufficient. This eliminates the need for periodic inspections by human operators and ensures safety of the fuel cell power generation system sufficiently.

In this case, the fuel cell power generation system may further comprise a display unit, and wherein the display unit displays information indicating an abnormal state if the protective operation is executed according to at least one of the detection of abnormality and the determination of failure, while the display unit does not display the information if the protective operation is executed according to at least one of the abnormality self-diagnostic function and the failure self-diagnostic function based on the command signal associated with normal stop.

With such a configuration, the reason why the protective operation was carried out is displayed clearly, allowing the user of the fuel cell power generation system to make an appropriate decision and take an appropriate action.

Moreover, in the foregoing case, the fuel cell power generation system may further comprise a main controller device configured to control and monitor all the operations associated with power generation operation; and the main controller device stops the operations if an abnormality or failure occurs in at least one of the failure determination unit, the protection controller device, and the protective operation unit.

With such a configuration, even if an abnormality or a failure occurs in the failure determination unit, the protection controller device, or the protective operation unit, the main controller device stops the operation of the fuel cell power generation system completely. Therefore, it becomes possible to provide a fuel cell power generation system with further enhanced safety.

The present invention may be embodied in the manners described above and achieves the advantageous effect of making it possible to provide a fuel cell power generation system that is economical in maintenance costs, by periodically checking the protective operation through an abnormality detection or a failure detection even with deterioration over time of the sensor components and also performing self-diagnosis, thereby eliminating the need for periodic inspections.

### BRIEF DESCRIPTION OF THE DRAWINGS

FIG. 1 is a configuration diagram schematically illustrating the configuration of a control system in a fuel cell power generation system.

FIG. 2 is a configuration diagram schematically illustrating as an example the configuration of a simulation signal generator.

FIG. 3 is a configuration diagram schematically illustrating as an example the configuration of another simulation signal generator.

FIG. 4 is a configuration diagram schematically illustrating as an example the configuration of another simulation signal generator.

FIG. 5 is a configuration diagram schematically illustrating the system configuration of a fuel cell power generation system.

FIG. 6 is a flow-chart illustrating a control operation of a fuel cell power generation system.

FIG. 7 is a block diagram schematically illustrating a failure diagnostic mechanism for a reformed gas supplying mechanism in a conventional fuel cell power generation system.

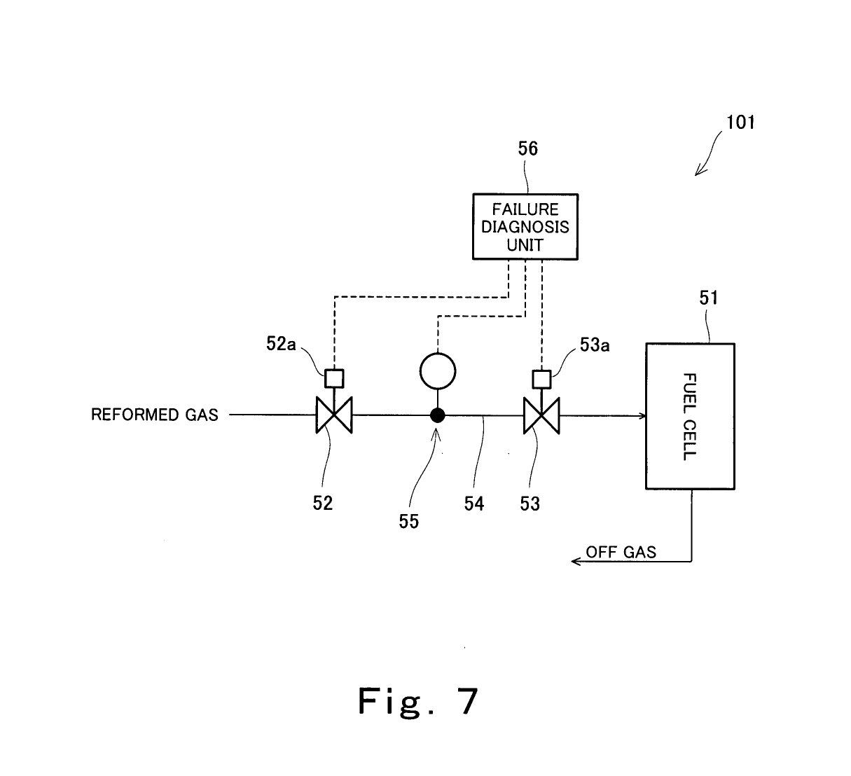

### DESCRIPTION OF REFERENCE NUMERALS

1 Sensor unit
2 Protection controller device
3 Failure determination unit
4 Protective operation unit
5 Simulation signal generator
5a, 5b Simulation signal generator
6 Start/stop command device
7 Display unit
11 Reformer
12 Combustor
13 Combustion exhaust gas passage
14 Raw fuel controlling means
15 Raw fuel supply passage
16 CO shift converter
17 CO remover
18 Fuel cell stack
19 Hydrogen supply passage
20 Air supply passage
21 Reaction air supplying means
22 Combustion air controlling means
23 Off gas supply passage
24 Electric output control device
51 Fuel cell
52 First open/close valve
52a Actuator
53 Second open/close valve
53a Actuator
54 Reformed gas supplying pipe
55 Pressure sensor
56 Failure diagnosis unit
100 Fuel cell power generation system
101 Failure diagnostic mechanism
102 Control system
103 Main controller device
104 Housing
SW 1-SW7 Switch
a-e Wire
b′ Wire
T Temperature sensor
P Pressure sensor
V Voltage sensor
I Current sensor
R Revolution sensor
G Combustible gas sensor
F Raw fuel shutoff unit
E Electric output shutoff unit
R1 to R4 Resistor

### BEST MODE FOR CARRYING OUT THE INVENTION

Hereinbelow, embodiments of the present invention are described with reference to the drawings.

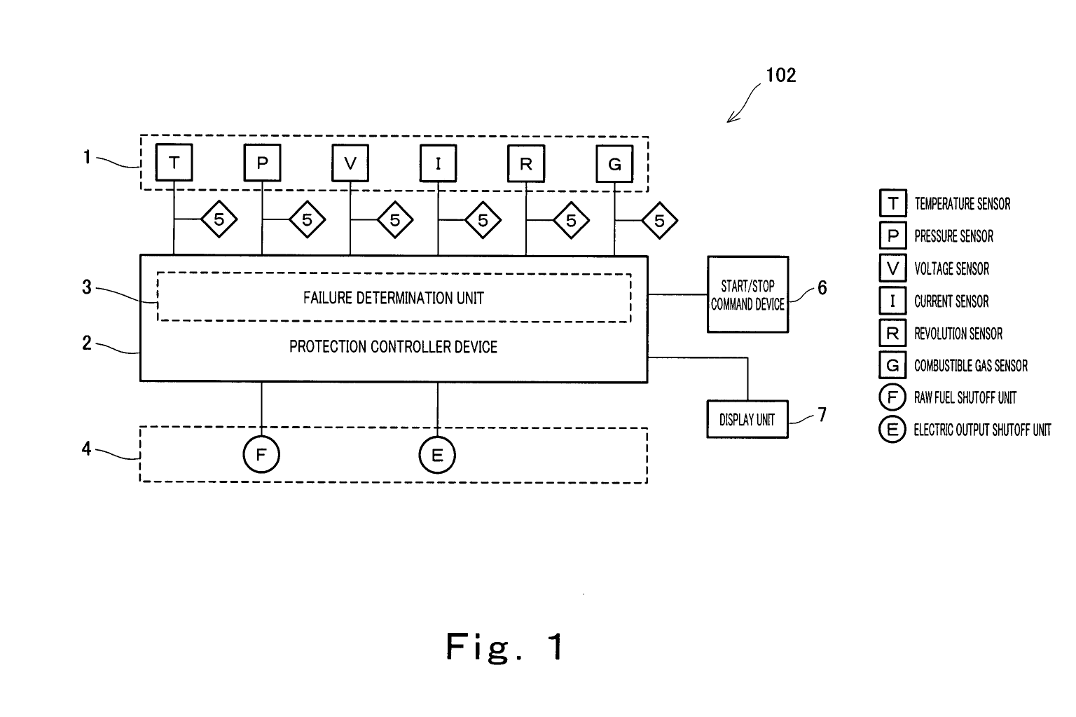

FIG. 1 is a configuration diagram schematically illustrating the configuration of a control system in a fuel cell power generation system according to an embodiment of the present invention. Herein, the term “control system” means a system that functions to ensure safety of the power generation operations (for example, a failure diagnostic mechanism) in the fuel cell power generation system.

As illustrated in FIG. 1, a control system 102 according to the present embodiment has a sensor unit 1 for detecting operation states of the fuel cell power generation system (for example, temperatures and pressures in a reformer, not shown in FIG. 1, for generating a reformed gas to be supplied to a fuel cell; temperatures of the fuel cell that generates electric power using the reformed gas and air; numbers of revolutions of blowers and the like in a combustion air controlling means and a reaction air supplying means that supply necessary air to the reformer and the fuel cell; voltage values and current values of the electric power obtained by electric power generation with the fuel cell; concentrations of combustible gases such as the reformed gas inside the housing of the fuel cell power generation system; etc.). In the present embodiment, the sensor unit 1 comprises a plurality of sensors, such as a temperature sensor T, a pressure sensor P, a voltage sensor V, a current sensor I, a revolution sensor R, and a combustible gas sensor G. The sensor unit 1 is configured to be capable of sensing an abnormality in the operation states of the fuel cell power generation system. Here, in the present specification, the term “abnormality in operation states” means a state in which the temperature, the pressure, the number of revolutions, the voltage value or current value, or the concentration that is detected by the sensor unit 1 falls out of a predetermined permissible range. As shown in FIG. 1, the sensor unit 1 and a later-described protection controller device 2 are electrically connected to each other by a predetermined wire.

The control system 102 has the protection controller device 2 configured to output a predetermined protective operation command signal for ensuring safety of the fuel cell power generation system based on at least an output signal that is output by the sensor unit 1. The protection controller device 2 contains a failure determination unit 3 that is capable of determining whether a failure has occurred in the sensor unit 1. As illustrated in FIG. 1, the protection controller device 2 and a later-described protective operation unit 4 are electrically connected to each other by a predetermined wire.

The control system 102 also has the protective operation unit 4 that performs a predetermined protective operation for ensuring safety of the fuel cell power generation system based on a predetermined protective operation command signal that is output by the protection controller device 2. In the present embodiment, the protective operation unit 4 comprises a raw fuel shutoff unit F and an electric output shutoff unit E. Here, the raw fuel shutoff unit F has the function to shut off the supply of hydrocarbon or the like (raw fuel) such as methane, which serves as the raw material for generating a reformed gas to be supplied to the reformer, when the need arises. On the other hand, the electric output shutoff unit E, obtained by electric power generation of the fuel cell, has the function to shut off the output of electric power from the fuel cell power generation system, when the need arises.

In addition, the control system 102 has a plurality of simulation signal generators 5 each of which outputs a simulation signal for forcing the protection controller device 2 to output the above-mentioned predetermined protective operation command signal. These simulation signal generators 5 are provided between the sensor unit 1 and the protection controller device 2 respectively a the temperature sensor T, a pressure sensor P, a voltage sensor V, a current sensor I, a revolution sensor R, and a combustible gas sensor G. When the simulation signal that is output by the simulation signal generators 5 is input into the protection controller device 2, the protection controller device 2 outputs the above-mentioned predetermined protective operation command signal. Consequently, the protective operation unit 4 performs a predetermined protective operation based on the predetermined protective operation command signal that is output from the protection controller device 2.

Here, the configuration of the simulation signal generator 5 will be illustrated below.

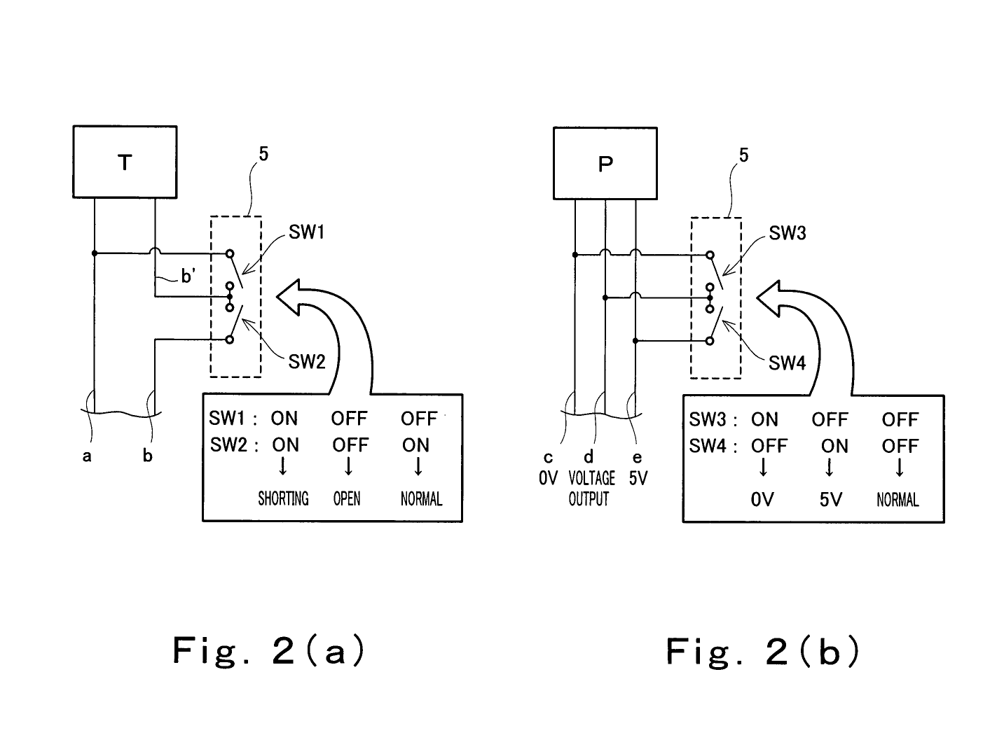

FIG. 2 shows configuration diagrams each schematically illustrating the configuration of a simulation signal generator according to the present embodiment. FIG. 2(a) shows the configuration of a simulation signal generator associated with the temperature sensor T. FIG. 2(b) shows the configuration of a simulation signal generator associated with the pressure sensor P. In the present embodiment, the configurations of the simulation signal generators associated with the voltage sensor V, the current sensor I, the revolution sensor R, and the combustible gas sensor G are the same as the configuration shown in FIG. 2(b). The configurations of the simulation signal generators shown in FIGS. 2(a) and 2(b) are provided merely for illustrative purposes, and the simulation signal generators may be constructed, for example, by other electronic circuits and the like.

As shown in FIG. 2(a), the simulation signal generator 5 associated with the temperature sensor T comprises switches SW1 and SW2. The switches SW1 and SW2 are connected to each other by respective ones of the terminals thereof, which are further electrically connected to a wire b′ that extends from the temperature sensor T. The other one of the terminals of the switch SW1 is electrically connected to a wire a that extends from the temperature sensor T. Further, the other one of the terminals of the switch SW2 is electrically connected to a wire b. The wires a and b are connected respectively to connecting terminals, not particularly shown, of the protection controller device 2 shown in FIG. 1.

In the simulation signal generator 5 associated with the temperature sensor T that is shown in FIG. 2(a), the wires a and b are put into a shorting state when the switch SW1 is switched to the ON state while the switch SW2 is in the ON state. This simulates the abnormal state resulting from a short circuit of, for example, a thermistor that constitutes the temperature sensor T. When the switch SW1 is switched to the OFF state while the switch SW2 is in the ON state, the simulated shorting state of the thermistor is cancelled. On the other hand, when the switch SW2 is switched to the OFF state while the switch SW1 is in the OFF state, the wire b′ is put into a disconnected state (open state). This simulates, for example, the abnormal state of open of the thermistor. When the switch SW2 is switched to the ON state while the switch SW1 is in the OFF state, the simulated open state of the thermistor is cancelled. In this way, the shorting state and open state of the temperature sensor T are simulated by controlling the switches SW1 and SW2 in the simulation signal generator 5.

As shown in FIG. 2(b), the simulation signal generator 5 associated with the pressure sensor P comprises switches SW3 and SW4. The switches SW3 and SW4 are connected to each other by respective ones of the terminals thereof, which are further electrically connected to a wire d′ that extends from the sensing terminal of the pressure sensor P. The other one of the terminals of the switch SW3 is electrically connected to a wire c that extends from the pressure sensor P and whose potential is kept at 0 V. Further, the other one of the terminals of the switch SW4 is electrically connected to a wire e that extends from the pressure sensor P and whose potential is kept at 5 V. The wires c, d, and e are connected respectively to connecting terminals, not particularly shown, of the protection controller device 2 shown in FIG. 1.

In the simulation signal generator 5 shown in FIG. 2(b) and associated with the pressure sensor P, the wires c and d are put into a shorting state when the switch SW3 is switched to the ON state while the switch SW4 is in the OFF state. Here, assuming that the normal voltage range that can be output from the sensing terminal of the pressure sensor P is from 1 V to 2 V, putting the wires c and d into a shorting state will cause the potential of the wire d to be 0 V; therefore, it is made possible to simulate an abnormal state of the pressure sensor P. When the switch SW3 is switched to the OFF state while the switch SW4 is in the OFF state, the simulated abnormal state of the pressure sensor P is cancelled. On the other hand, when the switch SW4 is switched to the ON state while the switch SW3 is in the OFF state, the wires d and e are put into a shorting state. Here, under the foregoing assumption, putting the wires d and e into a shorting state will cause the potential of the wire d to be 5 V; therefore, it is made possible to simulate an abnormal state of the pressure sensor P. When the switch SW4 is switched to the OFF state while the switch SW3 is in the OFF state, the simulated abnormal state of the pressure sensor P is cancelled. In this way, abnormal states of the pressure sensor P are simulated by controlling the switches SW3 and SW4 in the simulation signal generator 5.

Furthermore, as for the simulation signal generators 5 shown in FIG. 2 and associated respectively with the temperature sensor T and the pressure sensor P, it is also possible to clearly distinguish the abnormal state and the failure state in the temperature sensor T and the pressure sensor P from each other when simulating them.

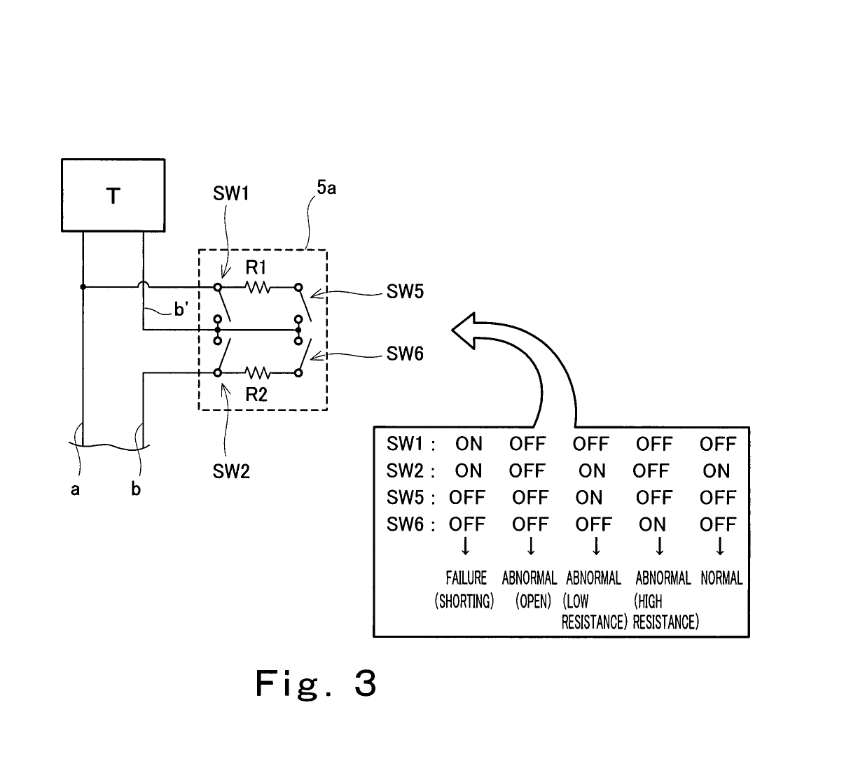

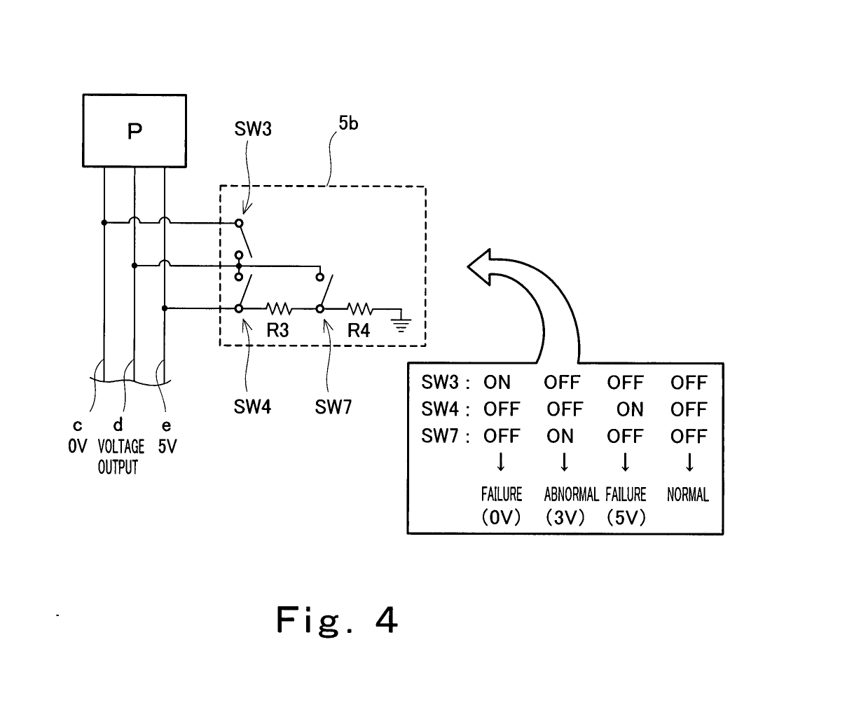

FIGS. 3 and 4 are configuration diagrams schematically illustrating the configurations of other simulation signal generators according to the present embodiment. FIG. 3 shows the configuration of another simulation signal generator associated with the temperature sensor T. FIG. 4 shows the configuration of another simulation signal generator associated with the pressure sensor P. In the present embodiment, the configurations of the other simulation signal generators associated with the voltage sensor V, the current sensor I, the revolution sensor R, and the combustible gas sensor G are the same as the configuration shown in FIG. 4.

As shown in FIG. 3, another simulation signal generator 5a associated with the temperature sensor T comprises switches SW1 and SW2, switches SW5 and SW6, and resistors R1 and R2. The switches SW1 and SW2, as well as the switches SW5 and SW6, are connected to each other by respective ones of the terminals thereof, which are electrically connected further to a wire b′ extending from the temperature sensor T. The other one of the terminals of the switch SW1 is electrically connected to a wire a extending from the temperature sensor T. The other one of the terminals of the switch SW5 is electrically connected to the wire a extending from the temperature sensor T. The other one of the terminals of the switch SW2 is electrically connected to the wire b. The other one of the terminals of the switch SW6 is electrically connected to the wire b via the resistor R2. The wires a and b are connected respectively to connecting terminals, not particularly shown in the figures, of the protection controller device 2 shown in FIG. 1.

In the other simulation signal generator 5a shown in FIG. 3 and associated with the temperature sensor T, the wires a and b are put into a shorting state when the switch SW1 is switched to the ON state while the switch SW2 is in the ON state and the switches SW5 and SW6 are in the OFF state. This simulates the failure state resulting from a short circuit of, for example, a thermistor that constitutes the temperature sensor T. On the other hand, when the switch SW1 is switched to the OFF state while the switch SW2 is in the ON state and the switches SW5 and SW6 are in the OFF state, the simulated shorting state of the thermistor is cancelled.

When the switch SW2 is switched to the OFF state while the switch SW1 is in the OFF state and the switches SW5 and SW6 are also in the OFF state, the wires b and b′ are switched to a disconnected state (open state). This simulates the failure state resulting from, for example, opening of the thermistor. On the other hand, when the switch SW2 is switched to the ON state while the switch SW1 is in the OFF state and the switches SW5 and SW6 are also in the OFF state, the simulated open state of the thermistor is cancelled.

When the switch SW5 is switched to the ON state while the switch SW2 is in the ON state and the switches SW1 and SW6 are in the OFF state, the resistance value between the wires a and b results in a combined resistance value of the resistance value of the thermistor and the resistance value of the resistor R1 in parallel by selecting an appropriate resistance value for the resistance value of the resistor R1; therefore, the resistance value between the wires a and b may be made a low resistance value that does not reach the resistance value range within which the resistance value of the thermistor can change. This simulates an abnormal state of the thermistor that constitutes the temperature sensor T. When the switch SW5 is switched to the OFF state while the switch SW2 is in the ON state and the switches SW1 and SW6 are in the OFF state, the simulated abnormal state of the thermistor is cancelled.

When the switch SW6 is switched to the ON state while the switch SW2 is in the OFF state and the switches SW1 and SW5 are also in the OFF state, the resistance value between the wires a and b results in a combined resistance value of the resistance value of the thermistor and the resistance value of the resistor R2 in series by selecting an appropriate resistance value for the resistance value of the resistor R2; therefore, the resistance value between the wires a and b can be made a high resistance value exceeding the resistance value range within which the resistance value of the thermistor can change. This simulates an abnormal state of the thermistor that constitutes the temperature sensor T. When the switch SW6 is switched to the OFF state while the switch SW2 is in the ON state and the switches SW1 and SW5 are in the OFF state, the simulated abnormal state of the thermistor is cancelled.

In this way, abnormal states of the temperature sensor T can be simulated by controlling the switches 1 and 2 as well as the switches 5 and 6 appropriately in the simulation signal generator 5a.

On the other hand, as illustrated in FIG. 4, another simulation signal generator 5b associated with the pressure sensor P comprises switches SW3, SW4, and SW7, and resistors R3 and R4. The switches SW3, SW4, and SW7 are connected to one another by respective ones of the terminals thereof, which are further electrically connected to a wire d extending from the sensing terminal, not particularly shown in the figures, of the pressure sensor P. Also as shown in FIG. 4, the other one of the terminals of the switch SW3 is electrically connected to a wire c that extend from the pressure sensor P and whose potential is kept at 0 V. The other one of the terminals of the switch SW4 is electrically connected to a wire e that extends from the pressure sensor P and whose potential is kept at 5 V. As shown in FIG. 4, the other one of the terminals of the switch SW7 is also electrically connected to the wire e that extends from the pressure sensor P and whose potential is kept at 5 V via the resistor R3. The other one of the terminals of the switch SW7 is grounded via the resistor R4. The wires c, d, and e are connected to connecting terminals, not particularly shown in the figures, of the protection controller device 2 shown in FIG. 1.

In the other simulation signal generator 5b shown in FIG. 4 and associated with the pressure sensor P, when the switch SW3 is switched to the ON state while the switches SW4 and SW7 are in the OFF state, the wires c and d are put into a shorting state. Here, assuming that the normal range of the voltage that can be output from the sensing terminal of the pressure sensor P is from 1 V to 2 V, putting the wires c and d into a shorting state will cause the potential of the wire d to be 0 V; therefore, it is made possible to simulate a failure state of the pressure sensor P. When the switch SW3 is switched to the OFF state while the switches SW4 and SW7 are in the OFF state, the simulated failure state of the pressure sensor P is cancelled.

When the switch SW4 is switched to the ON state while the switches SW3 and SW7 are in the OFF state, the wires d and e are put into a shorting state. Here, under the foregoing assumption, putting the wires d and e into a shorting state will cause the potential of the wire d to be 5V; therefore, it is made possible to simulate a failure state of the pressure sensor P. When the switch SW4 is switched to the OFF state while the switches SW3 and SW7 are in the OFF state, the simulated failure state of the pressure sensor P is cancelled.

In addition, when the switch SW7 is switched to the ON state while the switches SW3 and SW4 are in the OFF state, the wire d is connected to a connected part between the resistor R3 and the resistor R4. Here, in the case that the wire d is connected to the portion at which the resistor R3 and the resistor R4 are connected, selecting appropriate resistance values for the respective resistance values of the resistors R3 and R4 allows the potential of the wire d to be, for example, 3 V, which is divided by the resistors R3 and R4. In other words, under the foregoing assumption, it is made possible to simulate an abnormal state of the pressure sensor P. When the switch SW7 is switched to the OFF state while the switches SW3 and SW4 are in the OFF state, the simulated abnormal state of the pressure sensor P is cancelled.

In this way, abnormal states of the pressure sensor P can be simulated by controlling the switches 3, 4 and 7 appropriately in the simulation signal generator 5b.

Thus, in the present embodiment, the simulation signal generator 5 (or the simulation signal generators 5a and 5b) operates to output a simulation signal for simulating an abnormality (failure) in the sensor unit 1. Then, when the simulation signal that is output by the simulation signal generator 5 is input into the protection controller device 2, a predetermined protective operation command signal is output from the protection controller device 2. Consequently, the protective operation unit 4 performs a predetermined protective operation based on this predetermined protective operation command signal that is output from the protection controller device 2. It should be noted that the operations of the simulation signal generator 5, the simulation signal generator 5a, and the simulation signal generator 5b including ON/OFF of the switches SW1 to SW7 are controlled by the protection controller device 2 appropriately.

Moreover, as illustrated in FIG. 1, the control system 102 according to the present embodiment has a start/stop command device 6 that controls the start or stop of the power generation operation of the fuel cell power generation system. This start/stop command device 6 controls the start or stop of the power generation operation of the fuel cell power generation system via the protection controller device 2 and so forth. Here, as illustrated in FIG. 1, the start/stop command device 6 and the protection controller device 2 are electrically connected to each other by a predetermined wire.

Furthermore, the control system 102 has a display unit 7 that displays information indicating that an abnormal state has occurred in the fuel cell power generation system at the time of the protective operation by the protective operation unit 4. The display unit 7 and the protection controller device 2 are electrically connected to each other by a predetermined wire. This display unit 7 may be disposed in the main unit of the fuel cell power generation system, or in a remote control unit for the fuel cell power generation system.

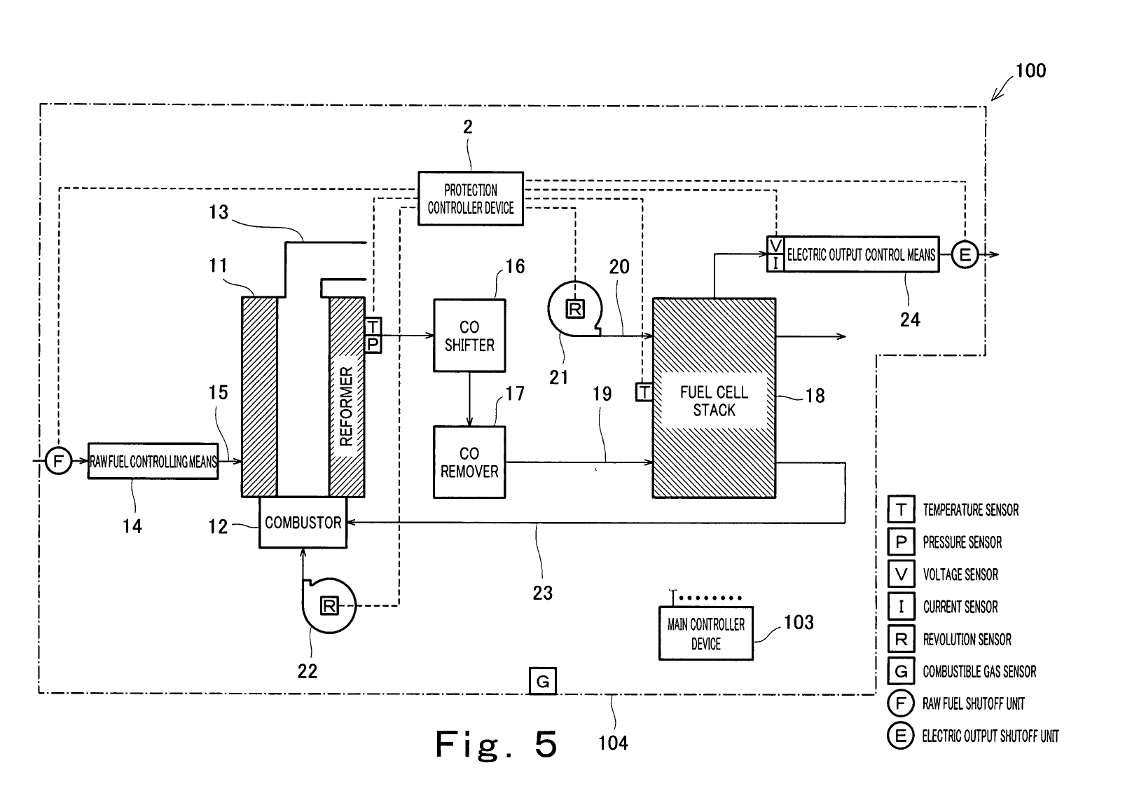

Next, the configuration of a fuel cell power generation system incorporating the above-described sensor unit 1, the protection controller device 2, the protective operation unit 4, and so forth is discussed with reference to the drawings. It should be noted that same components as those shown in FIG. 1 are designated by same reference numerals, to avoid unnecessary duplication and description thereof. In addition, among the constituting components shown in FIG. 1, the simulation signal generators 5, the start/stop command device 6, and the display unit 7 are not shown in FIG. 5.

FIG. 5 is a configuration diagram schematically illustrating the system configuration of the fuel cell power generation system according to an embodiment of the present invention.

As illustrated in FIG. 5, a fuel cell power generation system 100 according to the present embodiment has a raw fuel controlling means 14 for supplying a hydrocarbon-based raw fuel such as methane to the reformer 11. This raw fuel controlling means 14 is connected to an infrastructure that can supply the raw fuel at all times and to a reformer 11, by a raw fuel supply passage 15.

In addition, the fuel cell power generation system 100 has a reformer 11 for generating a reformed gas using the raw fuel supplied from the raw fuel controlling means 14 via the raw fuel supply passage 15. This reformer 11 has a combustor 12 for heating a predetermined location of the reformer 11 to a temperature necessary to generate the reformed gas, and a combustion exhaust gas passage 13 for exhaust a combustion exhaust gas emitted from the combustor 12. Here, a combustion air controlling means 22 for supplying the air necessary for combustion and an off gas supply passage 23 for supplying an exhaust reformed gas (off gas) emitted from a fuel cell stack 18 are connected to the combustor 12. The other end of the off gas supply passage 23 is connected to the fuel cell stack 18. In addition, the raw fuel controlling means 14 and the raw fuel supply passage 15 are connected to the upstream side of the reformer 11, and a CO shift converter 16 and a CO remover 17 are connected to the downstream side of the reformer 11 via a predetermined pipe. In the CO shift converter 16 and the CO remover 17, carbon monoxide in the reformed gas exhausted from the reformer 11 is removed therefrom. The reformed gas from which carbon monoxide has been removed is supplied to the fuel cell stack 18 via a hydrogen supply passage 19.

Further, the fuel cell power generation system 100 comprises a reaction air supplying means 21 for supplying the air necessary for electric power generation. The air necessary for electric power generation is supplied to the fuel cell stack 18 by the reaction air supplying means 21 via an air supply passage 20.

The fuel cell power generation system 100 has the fuel cell stack 18 as the main unit of the power generation unit. This fuel cell stack 18 is connected to the CO remover 17 and the CO shift converter 16 via the hydrogen supply passage 19 and to the reaction air supplying means 21 via the air supply passage 20. In other words, using the reformed gas supplied via the hydrogen supplying passage 19 and the air supplied from the air supply passage 20, the fuel cell stack 18 performs electric power generation in order to output electric power.

Moreover, The fuel cell power generation system 100 has an electric output controlling means 24 for controlling the electric power generated from electric power generation by the fuel cell stack 18. This electric output controlling means 24 is electrically connected to an output terminal of the fuel cell stack 18 via a predetermined wire. By this electric output controlling means 24, the fuel cell power generation system 100 can output electric power, for example, suitable for home electric appliances.

Furthermore, this fuel cell power generation system 100 has a main controller device 103 for controlling and monitoring all the operations associated with the power generation operation of the fuel cell power generation system 100. A MPU or the like may be used suitably for the main controller device 103.

In addition, the fuel cell power generation system 100 has a housing 104 for enclosing various constituting components therein, such as the reformer 11, the fuel cell stack 18, the main controller device 103, and so forth, that constitute the fuel cell power generation system 100.

Here, as illustrated in FIG. 5, the sensor unit 1 shown in FIG. 1 is configured as follows in the embodiment of the present invention; the temperature sensors T are provided for the reformer 11 and the fuel cell stack 18, the pressure sensor P for the reformer 11, the voltage sensor V and the current sensor I for the electric output controlling means 24, the revolution sensors R for the reaction air supplying means 21 and the combustion air controlling means 22, and the combustible gas sensor G on an inner wall surface, for example, of the housing 104, respectively. Also as illustrated in FIG. 5, the protective operation unit 4 shown in FIG. 1 is as follows; the raw fuel shutoff unit F is provided in the raw fuel supply passage 15 at the upstream side of the raw fuel controlling means 14; the electric output shutoff unit E is provided at the output side of the electric output controlling means 24. Also as shown in FIG. 5, the protection controller device 2 is provided for controlling the operations of the protective operation unit 4 based on at least an output signal from the sensor unit 1. The sensor unit 1, the protective operation unit 4, and the protection controller device 2 are electrically connected to one another by predetermined wires, which are indicated by the dashed lines in FIG. 5.

Next, basic operations of the fuel cell power generation system 100 shown in FIG. 5 are described with reference to the drawings.

A hydrocarbon-based raw fuel, such as methane, supplied from the raw fuel controlling means 14 is supplied to the reformer 11 through the raw fuel supply passage 15. Then, the raw fuel is heated in the interior of the reformer 11 by the combustor 12 and converted into a reformed gas through the reforming reaction. At this time, the combustor 12 heats the raw fuel using the air supplied by the combustion air controlling means 22 and the off gas exhausted from the fuel cell stack 18.

The reformed gas generated by the reformer 11 is fed to the CO shift converter 16 and the CO remover 17, where carbon monoxide in the reformed gas is sufficiently removed, and thereafter, is supplied through the hydrogen supply passage 19 to the fuel cell stack 18. On the other hand, the air supplied from the reaction air supplying means 21 is supplied through the air supply passage 20 to the fuel cell stack 18. Hydrogen in the reformed gas and oxygen in the air, each supplied in the above-described manner, are used for the electrochemical reaction in the fuel cell stack 18. Thereby, the fuel cell stack 18 performs electric power generation.

Then, the electric power generated by the fuel cell stack 18 is output via the electric output controlling means 24 and used as utility power in households etc. It should be noted that, as described above, the remaining reformed gas that was not used in the fuel cell stack 18 for the electrochemical reaction is supplied to the combustor 12 through the off gas supply passage 23, and is used in the combustor 12 as a heating fuel for the reforming reaction.

During the operations of the fuel cell power generation system 100 having the configuration as illustrated in FIGS. 1 to 5, the protection controller device 2 outputs a protective operation command signal to the raw fuel shutoff unit F and the electric output shutoff unit E, each of which serves as the protective operation unit 4, if any of the following events occurs: if the temperature sensors T detects an abnormal temperature increase in the reformer 11 or in the fuel cell stack 18; if the pressure sensor P detects an abnormal pressure increase in the reformer 11; if the voltage sensor V detects an abnormal voltage increase or decrease in the fuel cell stack 18; if the current sensor I detects an abnormal current increase in the fuel cell stack 18; if the revolution sensor R detects an abnormal revolution (increase or decrease) of a motor in the reaction air supplying means 21 or in the combustion air controlling means 22; or if the combustible gas sensor G detects leakage of a combustible gas, such as the reformed gas, in the interior of the housing 104. In response to this, the raw fuel shutoff unit F stops supply of the raw fuel to the raw fuel controlling means 14, and the electric output shutoff unit E stops output of the electric power from the fuel cell stack 18 (from the electric output controlling means 24), so that, as a protective operation, the power generation operation of the fuel cell power generation system 100 can be stopped safely. At this time, the display unit 7 provided in a remote control unit or the like displays information indicating that an abnormal state has occurred, as needed.

In addition, during the operations of the fuel cell power generation system 100 having the configuration as illustrated in FIGS. 1 to 5, if any of the sensors that constitute the sensor unit 1 fails, the failure determination unit 3 of the protection controller device 2 determines that a failure has occurred in the sensors, and the protection controller device 2 outputs a protective operation command signal to the protective operation unit 4 in a similar manner to the case of the above-described abnormality detection. Thereby, as a protective operation, the power generation operation of the fuel cell power generation system 100 is stopped safely. In this case as well, the display unit 7 provided in a remote control unit or the like displays information indicating that an abnormal state has occurred, as needed. Here, a case in which a temperature sensor T has failed is discussed as a specific example. When a thermistor, as one example of the temperature sensor T, has failed, a possible cause of the failure is considered as its disconnection or shorting. In this case, the electrical resistance value of the thermistor results in either infinite or zero; therefore, if the electrical resistance value of the thermistor deviates from the range of the electrical resistance value corresponding to, for example, possible temperatures of the fuel cell stack 18 (in other words, if the resistance value exceeds the upper limit or falls below the lower limit), the failure determination unit 3 determines that a failure has occurred in the temperature sensor T, and based on this judgment, the power generation operation is stopped as a protective operation for safety.

Next, the abnormality self-diagnostic function that the fuel cell power generation system 100 provides will be described, which characterizes the present invention.

In the fuel cell power generation system 100 according to the present embodiment, even if the power generation operation is performed properly and the sensor unit 1 does not detect any abnormal state, the simulation signal generator 5 inputs a simulation signal as in the case that the sensor unit 1 detects an abnormality to the protection controller device 2 periodically (for example, every one year as in the case where a periodic inspection is carried out), to thereby check whether or not the protective operation can be properly performed in the fuel cell power generation system 100. If an abnormal temperature increase in a thermistor as one example of the temperature sensor T has been detected, the electrical resistance value of the thermistor falls below the electrical resistance value that corresponds to the threshold value of the abnormal temperature (in the case of negative characteristics element); therefore, it is possible to check the protective operation with the abnormality self-diagnostic function by causing the simulation signal generator 5 to output a simulation signal (or a shorting signal) that corresponds to the same low electrical resistance value as in the case that the abnormality of the thermistor is detected. The outputting of the simulation signal by the simulation signal generator 5 is executed with the configuration shown in FIG. 2.

Here, the periodic input of the simulation signal to the protection controller device 2 by the simulation signal generator 5 is executed by a timer, not particularly shown in FIG. 5, or a clock function that the main controller device 103 normally provides. For example, in the case of making use of the clock function, a memory section of the main controller device 103 stores the time at which the system has checked whether or not the protective operation can be performed properly. The main controller device 103 also calculates the next check time (for example, the time indicating one year later) for the protective operation and stores the calculated time in the memory section. Then, when the clock function confirms that the next check time for the protective operation has been reached, the main controller device 103 controls the simulation signal generator 5 so that it inputs the simulation signal to the protection controller device 2. A series of these control operations by the main controller device 103 is executed by software that is provided in the memory section of the main controller device 103.

Next, the failure self-diagnostic function provided for the fuel cell power generation system 100 will be described, which also characterizes the present invention.

In the fuel cell power generation system 100 according to the present embodiment, even if the power generation operation is performed properly and the failure determination unit 3 determines no failure in the sensor unit 1, the simulation signal generator 5 inputs a simulation signal as in the case of a failure in the sensor unit 1 to the protection controller device 2 periodically (for example, every one year as in the case where a periodic inspection is carried out), to thereby check whether or not the protective operation can be properly performed in the fuel cell power generation system 100. In the case that a failure of a thermistor as one example of the temperature sensor T is presumed, it is possible to check the protective operation with the failure self-diagnostic function by causing the simulation signal generator 5 to output a simulation signal indicating that the electrical resistance value of the thermistor exceeds the upper limit (or falls below the lower limit) as in the case of the abnormality self-diagnostic function. The outputting of the simulation signal by the simulation signal generator 5 is also executed with the configuration shown in FIG. 2.

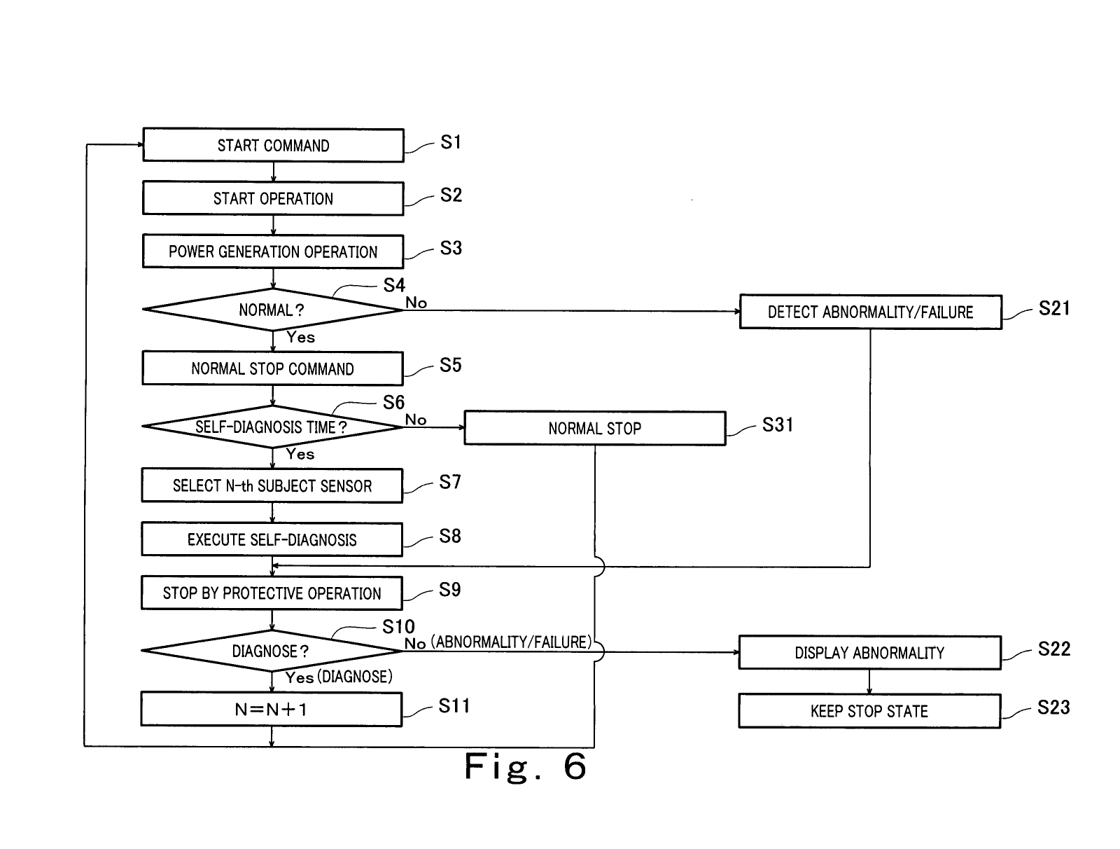

FIG. 6 is a flow-chart illustrating the control operation in the fuel cell power generation system.

In FIGS. 1 to 6, when the power generation operation of the fuel cell power generation system 100 is to be started, a predetermined start-up command (for example, a manual start with an operation switch or an automatic start by sensing an electric power load increase) is received from the start/stop command device 6 shown in FIG. 1 (step S1), and the start-up operation is started (step S2), followed by the power generation operation (step S3). At this stage, the sensor unit 1 shown in FIGS. 1 and 5 constantly monitors the state of the power generation operation to check whether it is normal or not. Then, if the sensor unit 1 detects an abnormality in the power generation operation or a failure in the sensor unit 1 (No at step S4), the abnormality/failure detection is executed in the above-described manner (step S21), and the power generation operation is stopped by the protective operation of the protective operation unit 4 (step S9). At this stage, if it is determined that the stop of the power generation operation by the protective operation is due to an abnormality in the power generation operation or a failure in the sensor unit 1 (No at step S10), the display unit 7 provided in a remote control unit or the like displays information indicating the abnormality (step S22) and the stop state of the power generation operation is sustained in the fuel cell power generation system 100 (step S23).

On the other hand, if the power generation operation of the fuel cell power generation system 100 is performed properly (Yes at step S4), and if a normal stop command (for example, manual stop with an operation switch or an automatic stop by sensing an electric load decrease) is output from the start/stop command device 6 to stop the power generation operation (step S5), a normal stop is performed in the normal condition (No at step S6, then step S31). But if it is determined that a periodic self-diagnosis time (for example, every one year as in the case where periodic inspection is carried out) (Yes at step S6), the N-th sensor, which becomes the target, is selected among a plurality of sensors in the sensor unit 1 (step S7), and the abnormality self-diagnosis or the failure self-diagnosis is executed for the selected N-th sensor (step S8). Then, as a result of the execution of the self-diagnosis at step S8, the power generation operation of the fuel cell power generation system 100 is stopped by the protective operation of the protective operation unit 4 (step S9). At this time, if it is determined that the stop of the power generation operation by the protective operation is due to the self-diagnosis (Yes at step S10), it means that the stop was due to the protective operation by the self-diagnosis under the normal stop, so the abnormality display is not performed and the number of the sensor to be targeted in the sensor unit 1 is advanced by one, to prepare for the next self-diagnosis. Thereafter, the self-diagnosis is executed for the plurality of sensors in the sensor unit 1 one by one. It should be noted that the self-diagnosis for the plurality of sensors may be executed in a predetermined sequence, but the self-diagnosis for a specific sensor or specific sensors may be executed more frequently than for the others, taking the degree of deterioration over time and importance of each sensor in system safety into consideration.

In addition, as illustrated in FIG. 5, the fuel cell power generation system 100 according to the embodiment of the present invention is furnished with the main controller device 103 configured to control and monitor all the operations associated with the power generation operation. If an abnormality or failure occurs in at least one of the failure determination unit 3, the protection controller device 2, or the protective operation unit 4, the main controller device 103 forcibly stops all the operations of the fuel cell power generation system 100. This ensures safety of the power generation operation of the fuel cell power generation system 100 further.

Thus, the protective operation is checked with the abnormality self-diagnostic function or the failure self-diagnostic function if the protection controller device 2 receives a normal stop command from the start/stop command device 6. This does not require unnecessary system stop, and the abnormal state resulting from the protective operation does not appear on the display unit. Therefore, the self-diagnosis is performed automatically without the user being aware of it.

Moreover, according to the present invention, the simulation signal generator 5 (or the simulation signal generators 5a and 5b) is configured as shown in FIG. 2 (or FIGS. 3 and 4), and therefore both the failure state and the abnormal state in the temperature sensor T, the pressure sensor P, the voltage sensor V, the current sensor I, the revolution sensor R, and the combustible gas sensor G can be simulated easily and simply when the need arises.

Thus, according to the present invention, the protective operation is checked periodically and a self-diagnosis is conducted using the abnormality detection and the failure detection even with deterioration over time of a sensor component such as a pressure sensor. This eliminates the need for periodic inspections and makes it possible to lower the maintenance cost of the fuel cell power generation system.

### INDUSTRIAL APPLICABILITY

The fuel cell power generation system according to the present invention is useful as a fuel cell power generation system that is economical in maintenance costs, since the need for periodic inspections is eliminated by periodically checking a protective operation through an abnormality detection and a failure detection even with deterioration over time of sensor components and also performing self-diagnosis.

Moreover, the fuel cell power generation system according to the present invention is applicable to various uses, such as automobile power supplies for electric vehicles.

1. A fuel cell power generation system comprising: a sensor unit capable of sensing an abnormality in operation states; a protection controller device configured to output a predetermined protective operation command signal based on at least an output signal from said sensor unit; a protective operation unit configured to perform a predetermined protective operation based on the protective operation command signal that is output from said protection controller device; and a simulation signal generator configured to output a simulation signal for causing said protection controller device to output the protective operation command signal;
said fuel cell power generation system having an abnormality self-diagnostic function to check the protective operation of said protective operation unit by inputting the simulation signal into said protection controller device by said simulation signal generator and thereby causing said protection controller device to output the protective operation command signal; and
said protection controller device including a failure determination unit configured to determine a failure in said sensor unit; and
said fuel cell power generation system having a failure self-diagnostic function to check the protective operation of said protective operation unit by outputting the protective operation command signal from said protection controller device if said failure determination unit determines a failure in said sensor unit, and by inputting the simulation signal into said protection controller device by said simulation signal generator to cause said protection controller device to output the protective operation command signal even if said failure determination unit determines no failure in said sensor unit.

2. The fuel cell power generation system according to claim 1, wherein the checking of the protective operation is performed with at least one of said abnormality self-diagnostic function and said failure self-diagnostic function periodically.

3. The fuel cell power generation system according to claim 1, further comprising:
a raw fuel shutoff unit configured to shut off supply of a raw fuel necessary to generate electric power, and an electric output shutoff unit configured to shut off electric power output from electric power generation; and wherein
said protective operation unit comprises at least one of said raw fuel shutoff unit or said electric output shutoff unit.

4. The fuel cell power generation system according to claim 3, wherein said sensor unit comprises at least one of a temperature sensor, a pressure sensor, a voltage sensor, a current sensor, a revolution sensor, and a combustible gas sensor.

5. The fuel cell power generation system according to claim 4, further comprising:
a start/stop command device configured to control start-up or stop of power generation operation; and wherein
the checking of the protective operation is performed with at least one of said abnormality self-diagnostic function and said failure self-diagnostic function when a command signal associated with normal stop of the power generation operation that is output from said start/stop command device is input into said protection controller device.

6. The fuel cell power generation system according to claim 5, wherein:
said sensor unit comprises a plurality of sensors having different sensing functions from one another; and
the checking of the protective operation is performed with at least one of said abnormality self-diagnostic function and said failure self-diagnostic function for said plurality of sensors in a predetermined sequence.

7. The fuel cell power generation system according to claim 6, further comprising:
a display unit; and wherein
said display unit displays information indicating an abnormal state if the protective operation is executed according to at least one of the detection of abnormally and the determination of failure, while said display unit does not display the information if the protective operation is executed according to at least one of said abnormality self-diagnostic function and said failure self-diagnostic function based on the command signal associated with normal stop.

8. The fuel cell power generation system according to claim 1, further comprising:
a main controller device configured to control and monitor all the operations associated with power generation operation; and wherein
said main controller device stops the operations if an abnormality or failure occurs in at least one of said failure determination unit, said protection controller device, or said protective operation unit.
